(19) United States
(12) Patent Application Publication
(10) Pub. No.: US 2019/0160789 A1
(43) Pub. Date: May 30, 2019

(54) LAMINATED GLASS STRUCTURES WITH BOW RESISTANCE

(71) Applicant: Corning Incorporated, Corning, NY (US)

(72) Inventors: Louis Mattos Jr., Painted Post, NY (US); Michael William Price, Corning, NY (US); James Ernest Webb, Coming, NY (US)

(21) Appl. No.: 16/098,301

(22) PCT Filed: May 2, 2017
(86) PCT No.: PCT/US17/30549

§ 371 Date: Nov. 1, 2018

Related U.S. Application Data
(60) Provisional application No. 62/330,540, filed on May 2, 2016.

(51) Int. Cl. B32B 17/06; B32B 7/12; B32B 15/12; B32B 15/20; B32B 29/00; B44C 5/04; B44F 1/06

(52) U.S. Cl. CPC B32B 17/065; B32B 7/12; B32B 15/12; B32B 15/20; B32B 29/005; B32B 2451/00; B44F 1/066; B32B 2260/028; B32B 2260/046; B32B 2307/7246; B32B 2307/546; B44C 5/0407

(57) ABSTRACT

A laminated glass structure is provided that includes a non-glass substrate, a flexible glass sheet, and an adhesive. The non-glass substrate includes one or more layers of polymer-impregnated paper, an upper primary surface and a lower primary surface. The non-glass substrate also comprises a lower moisture barrier at a selected depth from the lower primary surface. The flexible glass sheet has a thickness of no greater than 0.3 mm and is laminated to the upper primary surface of the non-glass substrate with the adhesive. An optional upper moisture barrier can also be included within the non-glass substrate at a selected depth from the upper primary surface.

This application claims the benefit of priority to U.S. Application No. 62/330,540, filed May 2, 2016, the content of which is incorporated herein by reference in its entirety.

### FIELD

The present disclosure relates to laminated glass structures and, more particularly, to laminated glass structures and designs configured for bow resistance, moisture insensitivity and temperature insensitivity.

### BACKGROUND

Laminated glass structures may be used as components in the fabrication of various appliances, automobile components, architectural structures, and electronic devices, to name a few. For example, laminated glass structures may be incorporated as cover glass for various end products such as refrigerators, backsplashes, decorative glazing or televisions. Laminated glass structures can also be employed in decorative wall panels, panels designed for ease-of-cleaning and other laminate applications in which a thin glass surface is valued.

However, laminated glass structures are typically comprised of non-glass substrates, adhesives and glass sheets. In these configurations, laminated glass structures can be particularly sensitive to changes in temperature and/or moisture, both of which alone or in combination can result in expansion and/or contraction of the non-glass substrates. In turn, the expansion and contraction effects associated with temperature and/or moisture can result in mechanical stresses within the laminated glass structures of increasing magnitude. These stresses can be manifested in bowing, cracking, defects, delamination and other defects that develop within the laminated glass structures as-manufactured or during their use during the lifetime of the products containing these structures.

Accordingly, there is a need for laminated glass structures and designs with bow resistance, moisture insensitivity and temperature insensitivity.

### SUMMARY

According to a first aspect of the disclosure, a laminated glass structure is provided that includes a non-glass substrate, a flexible glass sheet and an adhesive. The non-glass substrate includes one or more layers of polymer-impregnated paper, an upper primary surface and a lower primary surface. The non-glass substrate also comprises a lower moisture barrier at a selected depth from the lower primary surface. The flexible glass sheet has a thickness of no greater than 0.3 mm and is laminated to the upper primary surface of the non-glass substrate with the adhesive.

According to a second aspect, the structure of aspect 1 is provided, wherein the structure exhibits a change in bow of no more than ±10 mm upon exposure to a drying evolution at 70° C. for 24 hours.

According to a third aspect, the structure of aspect 1 or 2 is provided, wherein the structure exhibits a change in bow of no more than ±10 mm upon exposure to a high humidity evolution at 23° C. with a 90% relative humidity for 7 days.

According to a fourth aspect, the structure of any one of aspects 1-3 is provided, wherein the structure exhibits a change in bow of no more than ±10 mm upon exposure to a high humidity and temperature evolution at 40° C. with a 95% relative humidity for 96 hours.

According to a fifth aspect, the structure of any one of aspects 1-4 is provided, wherein the lower moisture barrier comprises an aluminum foil having a thickness from about 20 to about 60 microns.

According to a sixth aspect, the structure of any one of aspects 1-4 is provided, wherein: the lower moisture barrier has a thickness from about 20 to about 60 microns; the lower moisture barrier comprises a material selected from the group of materials consisting of a glass, a polymer, a metal, a ceramic, and a combination thereof; and the lower moisture barrier exhibits a moisture diffusivity of no more than 10,000 times the moisture diffusivity of the flexible glass sheet at 45° C.

According to a seventh aspect, the structure of any one of aspects 1-6 is provided, wherein the non-glass substrate further comprises a plurality of polymer-impregnated papers.

According to an eighth aspect, the structure of any one of aspects 1-7 is provided, wherein a total thickness of the non-glass substrate, the flexible glass sheet and the adhesive is from about 4 mm to about 25 mm.

According to a ninth aspect, the structure of any one of aspects 1-8 is provided, wherein the upper and lower primary surfaces each comprise a melamine-impregnated decorative layer.

According to a tenth aspect, the structure of any one of aspects 1-9 is provided, wherein the non-glass substrate further comprises an upper portion in proximity to the upper primary surface and a lower portion in proximity to the lower primary surface, and the lower portion exhibits lower moisture diffusivity than the moisture diffusivity of the upper portion.

According to an eleventh aspect of the disclosure, a laminated glass structure is provided that includes a non-glass substrate, a flexible glass sheet and an adhesive. The non-glass substrate includes one or more layers of polymer-impregnated paper, an upper primary surface and a lower primary surface. The non-glass substrate also comprises a lower moisture barrier at a selected depth from the lower primary surface and an upper moisture barrier at a selected depth from the upper primary surface. The flexible glass sheet has a thickness of no greater than 0.3 mm and is laminated to the upper primary surface of the non-glass substrate with the adhesive.

According to a twelfth aspect, the structure of aspect 11 is provided, wherein the structure exhibits a change in bow of no more than ±10 mm upon exposure to a drying evolution at 70° C. for 24 hours.

According to a thirteenth aspect, the structure of aspect 11 or 12 is provided, wherein the structure exhibits a change in bow of no more than ±10 mm upon exposure to a high humidity evolution at 23° C. with a 90% relative humidity for 7 days.

According to a fourteenth aspect, the structure of any one of aspects 11-13 is provided, wherein the structure exhibits a change in bow of no more than ±10 mm upon exposure to a high humidity and temperature evolution at 40° C. with a 95% relative humidity for 96 hours.

According to a fifteenth aspect, the structure of any one of aspects 11-14 is provided, wherein the upper and the lower moisture barrier comprises an aluminum foil having a thickness from about 20 to about 60 microns.

According to a sixteenth aspect, the structure of any one of aspects 11-14 is provided, wherein: each of the upper and the lower moisture barrier has a thickness from about 20 to about 60 microns; each of the upper and the lower moisture barrier comprises a material selected from the group consisting of a glass, a polymer, a metal, a ceramic, and a combination thereof; and each of the upper and lower moisture barriers exhibits a moisture diffusivity of no more than 10,000 times the moisture diffusivity of the flexible glass sheet at 45° C.

According to a seventeenth aspect, the structure of any one of aspects 11-16 is provided, wherein the non-glass substrate further comprises a plurality of polymer-impregnated papers.

According to an eighteenth aspect, the structure of any one of aspects 11-17 is provided, wherein a total thickness of the non-glass substrate, the flexible glass sheet and the adhesive is from about 4 mm to about 25 mm.

According to a nineteenth aspect, the structure of any one of aspects 11-18 is provided, wherein the upper and lower primary surfaces each comprise a melamine-impregnated decorative layer.

According to a twentieth aspect, the structure of any one of aspects 11-19 is provided, wherein the non-glass substrate further comprises an upper portion in proximity to the upper primary surface and a lower portion in proximity to the lower primary surface, and the lower portion exhibits a lower moisture diffusivity than the moisture diffusivity of the upper portion.

According to a twenty-first aspect, a laminated glass structure is provided that includes a non-glass substrate, a flexible glass sheet and an adhesive. The non-glass substrate includes a high pressure laminate (HPL), an upper primary surface and a lower primary surface. The non-glass substrate also comprises a lower moisture barrier at a selected depth from the lower primary surface. The flexible glass sheet has a thickness of no greater than 0.3 mm and is laminated to the upper primary surface of the non-glass substrate with the adhesive. The lower moisture barrier also has a thickness from about 20 microns to about 60 microns. A total thickness of the non-glass substrate, the flexible glass sheet and the adhesive is from about 4 mm to about 25 mm. Further, the structure exhibits a change in bow of no more than ±10 mm upon exposure to (a) a drying evolution at 70° C. for 24 hours; (b) a high humidity evolution at 23° C. with a 90% relative humidity for 7 days; and (c) a high humidity and temperature evolution at 40° C. with a 95% relative humidity for 96 hours.

According to a twenty-second aspect, the structure of aspect 21 is provided, wherein the lower moisture barrier comprises an aluminum foil.

According to a twenty-third aspect, the structure of aspect 21 is provided, wherein: the lower moisture barrier comprises a material selected from the group of materials consisting of a glass, a polymer, a metal, a ceramic, and a combination thereof; and the lower moisture barrier exhibits a moisture diffusivity of no more than 110% of the moisture diffusivity of the flexible glass sheet between 23° C. and 70° C.

According to a twenty-fourth aspect, the structure of any one of aspects 21-23 is provided, wherein the upper and lower primary surfaces each comprise a melamine-impregnated decorative layer.

According to a twenty-fifth aspect, the structure of any one of aspects 21-24 is provided, wherein the non-glass substrate further comprises an upper portion in proximity to the upper primary surface and a lower portion in proximity to the lower primary surface, and the lower portion exhibits lower moisture diffusivity than the moisture diffusivity of the upper portion.

Additional features and advantages will be set forth in the detailed description which follows, and in part will be readily apparent to those skilled in the art from the description or recognized by practicing the disclosure as exemplified in the written description and the appended drawings. It is to be understood that both the foregoing general description and the following detailed description are merely exemplary of the disclosure, and are intended to provide an overview or framework to understanding the nature and character of the disclosure as it is claimed.

The accompanying drawings are included to provide a further understanding of principles of the disclosure, and are incorporated in and constitute a part of this specification. The drawings illustrate one or more embodiment(s), and together with the description serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following aspects.

### BRIEF DESCRIPTION OF THE DRAWINGS

These and other features, aspects and advantages of the present disclosure are better understood when the following detailed description of the disclosure is read with reference to the accompanying drawings, in which:

FIG. 1 illustrates a cross-sectional view of a conventional laminated glass structure;

FIG. 1A illustrates the conventional laminated glass structure depicted in FIG. 1, as experiencing bow associated with high temperature and/or low humidity;

FIG. 1B illustrates the conventional laminated glass structure depicted in FIG. 1, as experiencing bow associated with high humidity;

FIG. 2 illustrates a cross-sectional view of an embodiment of a laminated glass structure with a lower moisture barrier in accordance with aspects of the disclosure;

FIG. 2A illustrates an exploded, cross-sectional view of a laminated glass structure with a lower moisture barrier in accordance with aspects of the disclosure;

FIG. 3 illustrates a cross-sectional view of an embodiment of a laminated glass structure with an upper and a lower moisture barrier in accordance with aspects of the disclosure; and

FIG. 3A illustrates an exploded, cross-sectional view of the laminated glass structure with an upper and a lower moisture barrier in accordance with aspects of the disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As also used herein, the term “moisture diffusivity” can be used interchangeably with “water vapor transmission rate.” Further, water vapor transmission rate (WVTR) can be measured with ASTM F1249-13 “Standard Test Method for Water Vapor Transmission Rate Through Plastic Film and Sheeting Using a Modulated Infrared Sensor” or ASTM E398-13 “Standard Test Method for Water Vapor Transmission Rate of Sheet Materials Using Dynamic Relative Humidity Measurement,” both of which are hereby incorporated by reference within this disclosure.

Disclosed herein are various laminated glass structures and designs with bow resistance, moisture insensitivity and/or temperature insensitivity. In general, these laminated glass structures include a non-glass substrate and a flexible glass sheet laminated to the substrate with an adhesive. The non-glass substrate comprises a moisture balancing material, element or barrier at or near the non-glass side of the non-glass substrate within the laminated glass structure to decrease the rate of moisture ingress or egress on this side of the structure. The non-glass substrate can comprise a similar or identical moisture balancing material, element or barrier at or near the glass side of the non-glass substrate within the laminated glass structure. By selecting and/or positioning a balancing element within the non-glass substrate such that it exhibits a moisture diffusivity that is comparable to or less than the moisture diffusivity through the flexible glass sheet, bow in the overall laminated glass structure can be eliminated or otherwise reduced to an acceptable level in the laminated glass structure as-manufactured and through its lifetime. Further, portions of the non-glass substrate on the non-glass side of the laminated glass structure, or all of the non-glass substrate, can be subjected to compositional modifications to reduce moisture diffusivity to decrease the rate of moisture ingress and egress on this side of the structure away from the flexible glass sheet with the same or similar benefits as the inclusion of a moisture balancing element or barrier.

The foregoing moisture balancing approaches, whether by moisture balancing elements and barriers, by compositional adjustments, or by combinations of these approaches, offer significant advantages to the laminated glass structures of the disclosure. For instance, these approaches can be tailored to the composition and moisture diffusivity of the flexible glass sheet employed in the laminated glass structure, facilitating design flexibility and manufacturability. Further, the moisture barriers, and any compositional modifications to the non-glass substrate, are generally hidden with the substrate, allowing both sides of the laminated glass structure to be fabricated with decorative surface features. In addition, these approaches foster enhanced manufacturability from a product cutting and shaping standpoint. In particular, these approaches do not significantly change the overall dimensions and mechanical properties of the laminated glass structure such that conventional cutting and polishing approaches (e.g., computer numerical control (CNC) machining, handheld routers, circular saws, drills, etc.) may still be employed to prepare the structures into their final product forms, even after lamination of the flexible glass sheet.

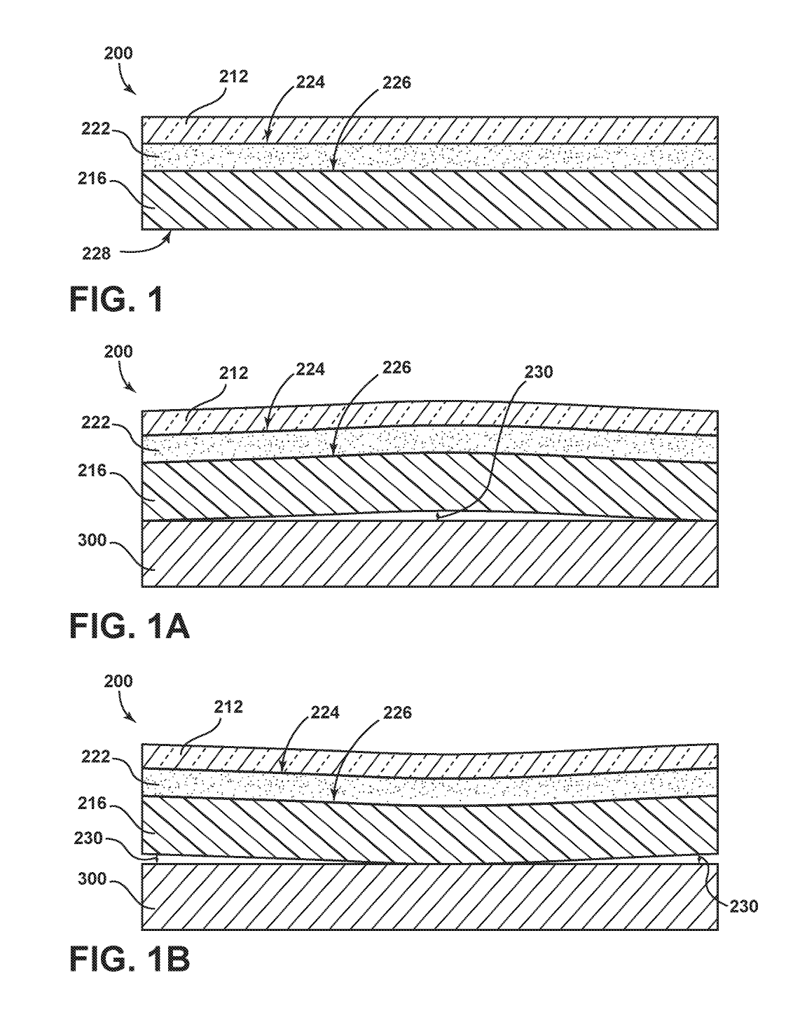

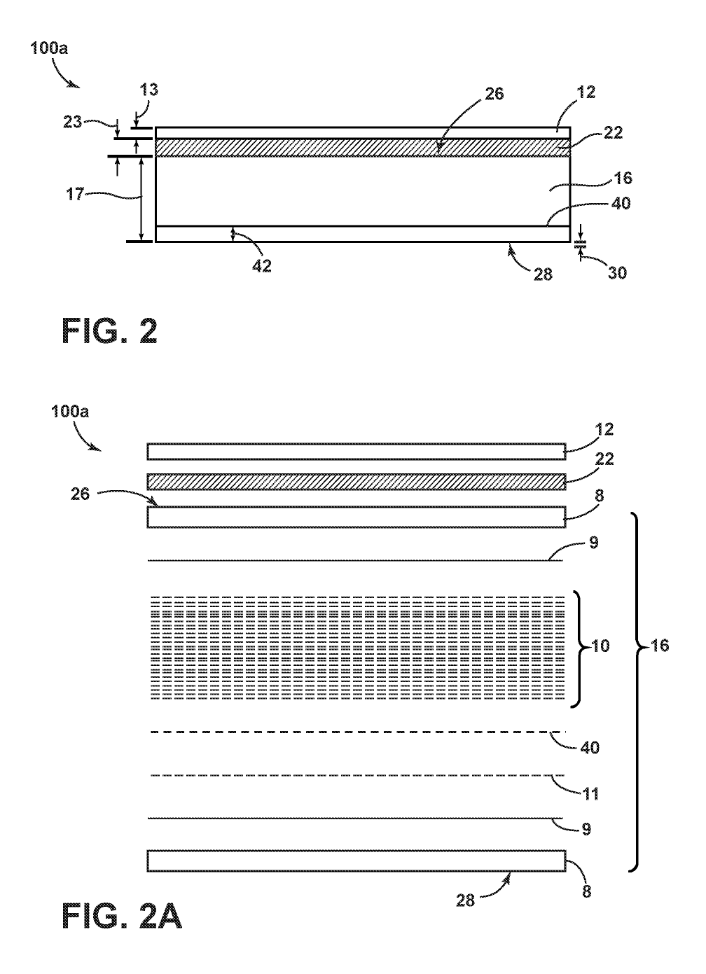

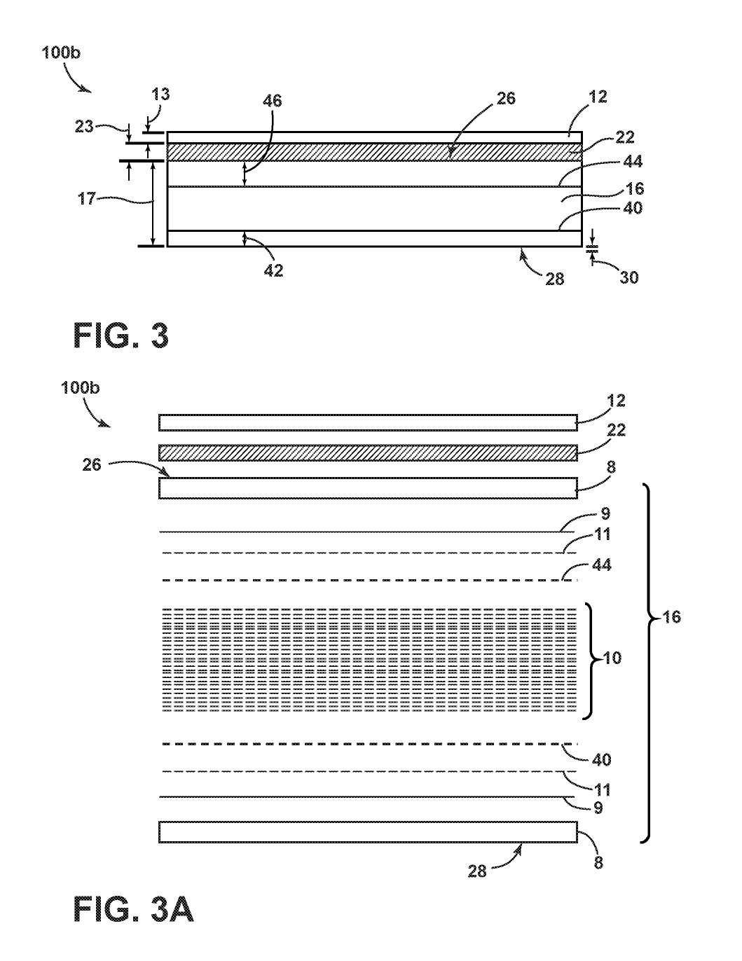

Referring to FIGS. 1, 1A and 1B, a conventional laminated glass structure is depicted to illustrate bowing problems that are overcome by the laminated glass structures of the disclosure (see, e.g., laminated glass structures 100a, 100b depicted in FIGS. 2, 2A, 3, 3A). A conventional laminated glass structure 200 that includes a glass sheet 212, adhesive 222 and non-glass substrate 216 is illustrated schematically in FIG. 1. A lower primary surface 224 of the glass sheet 212 is laminated to an upper primary surface 226 of the non-glass substrate 216 by the adhesive 222. Further, non-glass substrate 216 is shown with a lower primary surface 228, on the non-glass side of the conventional laminated glass structure 200.

Referring again to FIG. 1, when the glass sheet 212 is laminated to the upper primary surface 226 of the non-glass substrate 216, the resulting laminated glass structure 200 is an unbalanced condition. In particular, the glass sheet 212 forms a hermetic or nearly hermetic barrier over the non-glass substrate 216, which decreases the diffusion rate of water into and out of the non-glass substrate 216 through the upper primary surface 226. As a result, the diffusion rate of water into and out of the lower primary surface 228 and edges of the non-glass substrate 216 is higher than the diffusion rate of water into and out of the upper primary surface 226.

When the conventional laminated glass structure 200 is exposed to high-temperature and/or low humidity conditions, the non-glass substrate 216 will preferentially dry from the lower primary surface 228 and edges. This will result in shrinkage of the non-glass substrate in proximity to the lower primary surface 228 (i.e., the non-glass side of the laminated glass structure) and/or shrinkage of the non-glass substrate relative to the flexible glass sheet. In turn, the shrinkage will lead to bowing 230 of the conventional laminated glass structure 200 in an upward direction toward the glass sheet 212, as shown in FIG. 1A on a test surface 300. As used herein, upward bowing of a laminated glass structure is denoted by a positive (+) bowing value, which puts the glass sheet 212 in tension or in a concave orientation with respect to a direction toward the non-glass substrate.

Additionally, in high-humidity conditions, the non-glass substrate 216 of a conventional laminated glass structure 200 will preferentially absorb moisture through the lower primary surface 228. The net effect is that the moisture absorption will result in expansion of this side of the conventional laminated glass structure 200 and/or expansion of the non-glass substrate relative to the flexible glass sheet. As shown in FIG. 1B, the expansion of this side of the conventional laminated glass structure 200 on a test surface 300 will lead to bowing 230 in a downward direction away from the glass sheet 212. As used herein, downward bowing of a laminated glass structure is denoted by a negative (−) bowing value, which puts the glass sheet 212 in compression or in a convex orientation with respect to a direction toward the non-glass substrate.

Referring now to FIG. 2, an exemplary, laminated glass structure 100a is provided according to an embodiment of the disclosure. The laminated glass structure 100a includes a non-glass substrate 16, a flexible glass sheet 12 and a lower moisture barrier 40. The non-glass substrate 16 includes one or more layers of polymer-impregnated paper, an upper primary surface 26 and a lower primary surface 28. The flexible glass sheet 12 has a thickness 13 and is laminated to the upper primary surface 26 of the non-glass substrate 16 with an adhesive 22. The lower moisture barrier 40 is disposed within the non-glass substrate 16 at a selected depth 42 from the lower primary surface 28.

Within the laminated glass structure 100a, the non-glass substrate 16 is primarily comprised of non-glass materials. Particular examples of the non-glass substrate 16 include but are not limited to wood, fiberboard, laminate, composite, polymeric, metal and/or metal alloy materials. The metal alloys include but are not limited to stainless steel, aluminum, nickel, magnesium, brass, bronze, titanium, tungsten, copper, cast iron, ferrous steels, and noble metals. The non-glass substrate 16 may also include glass, glass-ceramic and/or ceramic materials as secondary constituents, e.g., fillers. In some embodiments, the non-glass substrate 16 includes polymer, wood or wood-based products such as chipboard, particleboard, fiberboard, cardboard, hardboard, or paper. For example, the non-glass substrate 16 comprises a low pressure laminate, a high pressure laminate, and/or a veneer.

As depicted in FIG. 2, the non-glass substrate 16 has a thickness 17 within the laminated glass structure 100a. In certain aspects, the thickness 17 of the non-glass substrate 16 ranges from about 1 mm to about 30 mm. For example, the thickness 17 can be 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm and all thickness values between these thicknesses. In one aspect, the thickness 17 of the non-glass substrate 16 is between about 2 mm and 25 mm.

In certain embodiments of the laminated glass structure 100a, the non-glass substrate 16 may be formed using a polymer material, for example, any one or more of polyethylene teraphthalate (PET), polyethylene Naphthalate (PEN), ethylene tetrafluoroethylene (ETFE), or thermopolymer polyolefin (TPO™—polymer/filler blends of polyethylene, polypropylene, block copolymer polypropylene (BCPP), or rubber), polyesters, polycarbonate, polyvinylbuterate, polyvinyl chloride, polyethylene and substituted polyethylenes, polyhydroxybutyrates, polyhydroxyvinylbutyrates, polyetherimides, polyamides, polyethylenenaphalate, polyimides, polyethers, polysulphones, polyvinylacetylenes, transparent thermoplastics, transparent polybutadienes, polycyanoacrylates, cellulose-based polymers, polyacrylates and polymethacrylates, polyvinylalcohol, polysulphides, polyvinyl butyral, polymethyl methacrylate and polysiloxanes. It is also possible to use polymers which can be deposited and/or coated as pre-polymers or pre-compounds and then converted, such as epoxy-resins, polyurethanes, phenol-formaldehyde resins, and melamine-formaldehyde resins. Many display and electrical applications may prefer acrylic-based polymers, silicones and such structural aiding layers, for example, commercially available SentryGlas® from DuPont. The polymer layers may be transparent for some applications, but need not be for other applications.

Referring again to FIG. 2, the flexible glass sheet 12 may be formed of glass, a glass ceramic, a ceramic material or composites thereof. A fusion process (e.g., a downdraw process) that forms high quality flexible glass sheets can be used in a variety of devices, and one such application is flat panel displays. Glass sheets produced in a fusion process have surfaces with superior flatness and smoothness when compared to glass sheets produced by other methods. The fusion process is described in U.S. Pat. Nos. 3,338,696 and 3,682,609, the disclosures of which are hereby incorporated by reference. Other suitable glass sheet forming methods include a float process, updraw and slot draw methods. Additionally, the flexible glass sheet 12 may also contain anti-microbial properties by using a chemical composition for the glass that includes or otherwise incorporates a silver ion concentration on the surface of the glass sheet, for example, in the range from greater than 0 to 0.047 μg/cm², as further described in U.S. Patent Application Publication No. 2012/0034435, the disclosure of which is hereby incorporated by reference. The flexible glass sheet 12 may also be coated with a glaze composed of silver, or otherwise doped with silver ions, to gain the desired anti-microbial properties, as further described in U.S. Patent Application Publication No. 2011/0081542, the disclosure of which is hereby incorporated by reference. Additionally, the flexible glass sheet 12 may have a molar composition of 50% SiO₂, 25% CaO, and 25% Na₂O to achieve the desired anti-microbial properties.

As depicted in FIG. 2, the flexible glass sheet 12 of the laminated glass structure 100a has a thickness 13. In certain aspects of the laminated glass structure 100a, the thickness 13 of the flexible glass sheet 12 is about 0.3 mm or less including but not limited to thicknesses of, for example, about 0.01-0.05 mm, about 0.05-0.1 mm, about 0.1-0.15 mm, about 0.15-0.3 mm, or about 0.1 to about 0.2 mm. The thickness 13 of the flexible glass sheet 12 can also be about 0.3 mm, 0.275 mm, 0.25 mm, 0.225 mm, 0.2 mm, 0.19 mm, 0.18 mm, 0.17 mm, 0.16 mm, 0.15 mm, 0.14 mm, 0.13 mm, 0.12 mm, 0.11 mm, 0.10 mm, 0.09 mm, 0.08 mm, 0.07 mm, 0.06 mm, 0.05 mm, 0.04 mm, 0.03 mm, 0.02 mm, 0.01 mm, or any thickness value between these thicknesses.

As further depicted in FIG. 2, the laminated glass structure 100a includes an adhesive 22 that can be employed to laminate the flexible glass sheet 12 to the upper primary surface 26 of the non-glass substrate 16. The adhesive 22 may be a non-adhesive interlayer, an adhesive, a sheet or film of adhesive, a liquid adhesive, a powder adhesive, a pressure sensitive adhesive, an ultraviolet-light curable adhesive, a thermally curable adhesive, or other similar adhesive or combination thereof. The adhesive 22 may assist in attaching the flexible glass sheet 12 to the non-glass substrate 16 during lamination. Some examples of low temperature adhesive materials include Norland Optical Adhesive 68 (Norland Products, Inc.) cured by ultra-violet (UV) light, FLEXcon V29TT adhesive, 3M™ optically clear adhesive (OCA) 8211, 8212, 8214, 8215, 8146, 8171, and 8172 (bonded by pressure at room temperature or above), 3M™ 4905 tape, OptiClear® adhesive, silicones, acrylates, optically clear adhesives, encapsulant material, polyurethane polyvinylbutyrates, ethylenevinylacetates, ionomers, and wood glues. Typical graphic adhesives such as Graphicmount and Facemount may also be used (as available from LexJet Corporation, located in Sarasota, Fla., for example). Some examples of higher temperature adhesive materials include DuPont SentryGlas®, DuPont PV 5411, Japan World Corporation material FAS and polyvinyl butyral resin. The adhesive 22 may be thin, having a thickness 23 of less than or equal to about 1000 μm, including less than or equal to about 500 μm, about 250 μm, less than or equal to about 50 μm, less than or equal to 40 μm, and less than or equal to about 25 μm. In other aspects, the thickness 23 of the adhesive 22 is between about 0.1 mm and about 5 mm. The adhesive 22 may also contain other functional components such as color, decoration, heat or UV resistance, AR filtration, etc. The adhesive 22 may be optically clear on cure, or may otherwise be opaque. In embodiments where the adhesive 22 is a sheet or film of adhesive, the adhesive 22 may have a decorative pattern or design visible through the thickness 13 of the flexible glass sheet 12.

As also depicted in FIG. 2, the adhesive 22 of the laminated glass structure 100a can be formed of a liquid, gel, sheet, film or a combination of these forms. Further, in some aspects, the adhesive 22 can exhibit a pattern of stripes that are visible from an outer surface of the flexible glass sheet 12. In some embodiments, the non-glass substrate 16 may provide a decorative pattern and/or the decorative pattern may be provided on either surface of the flexible glass sheet 12. In some embodiments, the decorative pattern may be provided within multiple layers, e.g., within flexible glass sheet 12, non-glass substrate 16 and/or adhesive 22. Some air bubbles may become entrained in the laminated glass structure 100a during or after lamination, but air bubbles having a diameter of equal to or less than 100 μm may not affect the impact resistance of the laminated glass structure 100a. Formation of air bubbles may be reduced by use of a vacuum lamination system or application of pressure to a surface of the structure 100a during lamination. In other embodiments, the flexible glass sheet 12 may be laminated without adhesive.

Referring again to FIG. 2, the overall thickness of the laminated glass structure 100a can range from about 1 mm to about 35 mm. In particular, the overall thickness of the laminated glass structure 100a is given by the sum of the thicknesses 13, 17 and 23 of the flexible glass sheet 12, non-glass substrate 16 and adhesive 22, respectively. Accordingly, the overall thickness of the laminated glass structure 100a can be about 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, and all thickness values between these overall thicknesses. In certain aspects, the overall thickness of the laminated glass structure 100a can range from about 4 mm to about 25 mm.

The laminated glass structure 100a depicted in FIG. 2 also includes a lower moisture barrier 40. The lower moisture barrier 40 is disposed within the non-glass substrate 16 at a selected depth 42 from the lower primary surface 28. In certain implementations, the selected depth 42 for the lower moisture barrier 40 is about half of the thickness 17 of the non-glass substrate 16 to about 1 micron from the lower primary surface 28 of the non-glass substrate 16. As an example, the lower moisture barrier 40 can have a selected depth 42 of about one fourth of the thickness 17 from the lower primary surface 28. More particularly, the lower moisture barrier 40 can help to decrease the rate of moisture ingress or egress at the lower primary surface 28 of the structure. The laminated glass structure also can include a similar or identical moisture balancing material, element or barrier at or near the glass side (i.e., the upper primary surface 26) of the non-glass substrate 16 within the laminated glass structure (see the upper moisture barrier 44 of the laminated glass structure 100b depicted in FIG. 3).

By selecting and/or positioning a moisture barrier, e.g., lower moisture barrier 40, within the non-glass substrate 16 such that it exhibits a moisture diffusivity that is comparable to or less than the moisture diffusivity through the flexible glass sheet 12, bow 30 in the overall laminated glass structure 100a can be eliminated or otherwise reduced to an acceptable level in the laminated glass structure 100a, as-manufactured and through its lifetime. A moisture barrier, e.g., lower moisture barrier 40, selected and positioned according to the foregoing principles is more effective at eliminating bow, particularly through the lifetime of the laminated glass structure 100a as it experiences various environmental conditions, compared to conventional balancing papers often employed in the industry. Further, a lower moisture barrier 40 is beneficially hidden or otherwise buried within the laminated glass structure 100a such that it does not detract from the aesthetics of the structure, affect its design flexibility in terms of possessing other decorative surfaces (e.g., on the lower primary surface 28), and/or impact the manufacturability and preparation of its final form (e.g., through cutting, sectioning, polishing and the like).

The lower moisture barrier 40 depicted in FIG. 2 can have a thickness that ranges from about 1 micron to about 100 microns. For example, the lower moisture barrier 40 can range in thickness from about 10 to 90 microns, 20 to 80 microns, 30 to 70 microns, 20 to 60 microns, 30 to 50 microns, 35 to 45 microns, about 40 microns, and all thickness values between these ranges. In certain aspects, the lower moisture barrier 40 can be sized for an additional aesthetic function such that it can be viewed edge-on within the laminated glass structure 100a.

Referring again to FIG. 2, the lower moisture barrier 40 can be fabricated from various materials including, but not limited to, a metal, a metal alloy, a glass, a glass-ceramic, a ceramic, a polymer, a composite and/or a combination of these materials. In an exemplary implementation, the lower moisture barrier 40 is fabricated from aluminum or an aluminum alloy in the form of a foil. Aluminum foil can exhibit a water vapor transmission rate (WVTR) of 0.001 g/m²*day or less and, in certain instances, may approach a WVTR of ˜0 g/m²*day, as reported in the open literature. In contrast, the WVTR of polymers, which may be used to fabricate the non-glass substrate 16, is significantly higher than the WVTR of aluminum foil as reported in the open literature (e.g., 0.7 to 1.47 g/m²*day for polypropylene and 2.4 to 4 g/m²*day for polyvinyl chloride as measured at 38° C.). In some embodiments, the material (or materials) selected for the lower moisture barrier 40 is chosen to approximate the moisture diffusivity or water vapor transmission rate (WVTR) of the flexible glass sheet 12. For example, the flexible glass sheet 12 can be fabricated from Corning® Willow® Glass, which has been reported in the open literature with a WVTR of <7×10⁻⁶ g/m²*day, as measured at 45° C. In other implementations, the material (or materials) selected for the lower moisture barrier 40 is chosen such that it exhibits a moisture diffusivity of no more than 10,000 times, no more than 1,000 times, or no more than 100 times the moisture diffusivity of the flexible glass sheet 12, e.g., as measured at 45° C. Accordingly, certain implementations of the laminated glass structure 100a can incorporate a lower moisture barrier 40 with a moisture diffusivity or WVTR that is greater than or comparable to the moisture diffusivity of the flexible glass sheet 12, while much lower than the bulk of the materials employed in the non-glass substrate 16.

With regard to bow resistance, moisture insensitivity and temperature insensitivity, the laminated glass structure 100a depicted in FIG. 2 can be characterized by various attributes. For example, certain implementations of the laminated glass structure 100a exhibit a change in bow 30 of no more than ±10 mm upon exposure to a drying evolution or a condition of 70° C. for 24 hours. In some embodiments, the change in bow 30 of the laminated glass structure 100a under such conditions is limited to no more than ±13 mm, ±12 mm, ±11 mm, ±10 mm, ±9 mm, ±8 mm, ±7 mm, ±6 mm, ±5 mm, and all changes in bow between these values.

Other implementations of the laminated glass structure 100a depicted in FIG. 2 exhibit a change in bow 30 of the laminated glass structure 100a of no more than ±10 mm upon exposure to a high humidity evolution or condition at 23° C. with a 90% relative humidity for 7 days. In some embodiments, the change in bow 30 of the laminated glass structure 100a under such conditions is limited to no more than ±13 mm, ±12 mm, ±11 mm, ±10 mm, ±9 mm, ±8 mm, ±7 mm, ±6 mm, ±5 mm, and all changes in bow between these values.

In another embodiment of the laminated glass structure 100a depicted in FIG. 2, the structure exhibits a change in bow 30 of no more than ±10 mm upon exposure to a high humidity and temperature evolution or condition at 40° C. with a 95% relative humidity for 96 hours. In certain aspects, the change in bow 30 of the laminated glass structure 100a under such conditions is limited to no more than ±13 mm, ±12 mm, ±11 mm, ±10 mm, ±9 mm, ±8 mm, ±7 mm, ±6 mm, ±5 mm, and all changes in bow between these values.

As used herein, a “change in bow,” “average bow change” and “average change in bow” are used interchangeably to denote a measured change in bow of a given laminated glass structure from a baseline measurement (i.e., before being subjected to a certain environmental condition) to a bow measurement conducted after the laminated glass structure is subjected to a given environmental condition. Further, measurements of bow in the disclosure are conducted according to a modified test method based on European Standard EN438 bow test method, which is incorporated herein by reference in its entirety. The modification relates to testing the laminated glass structures, each having a length of 36 inches, before and after being subjected to a given environmental test condition to calculate a “change in bow” associated with the condition. In addition, laminated glass structures with positive (+) bow are measured on a known, flat test surface at the point of maximum bow with the glass side of the structure oriented upward. Similarly, laminated glass structures with a negative (−) bow are measured on a known flat test surface at the point of maximum bow with the glass side of the structure oriented downward.

Referring now to FIG. 2A, another exemplary embodiment of a laminated glass structure 100a is depicted in the form of a laminated glass structure having a high-pressure laminate (HPL). Unless otherwise noted, the laminated glass structure 100a depicted in FIG. 2A includes the same features as the laminated glass structure 100a depicted in FIG. 2. For example, the laminated glass structure 100a shown in FIG. 2A includes a non-glass substrate 16, a flexible glass sheet 12 and a lower moisture barrier 40. Further, the laminated glass structure 100a shown in FIG. 2A can exhibit the same functionality as the structure 100a depicted in FIG. 2, including bow resistance, moisture insensitivity and/or temperature insensitivity. In particular, the laminated glass structure 100a can exhibit a change in bow of no more than ±10 mm upon exposure to (a) a drying evolution at 70° C. for 24 hours; (b) a high humidity evolution at 23° C. with a 90% relative humidity for 7 days; and (c) a high humidity and temperature evolution at 40° C. with a 95% relative humidity for 96 hours. However, the non-glass substrate 16 of the laminated glass structure 100a depicted in FIG. 2A more particularly includes a stack 10 of polymer-impregnated papers, a lower moisture barrier 40, polymer-impregnated decorative papers 9, a separate polymer-impregnated paper 11 and optional surface layers 8. In this configuration, the polymer-impregnated paper 11 is configured to assist or otherwise enable the joining of the polymer-impregnated decorative paper 9 to the lower moisture barrier 40.

In some embodiments, the laminated glass structure 100a has an overall thickness from about 4 mm to about 25 mm, and includes a non-glass substrate 16 in the form of an HPL with a stack 10 having about 1 to 100 phenolic resin-impregnated kraft papers, laminated under an above-ambient pressure. The lower moisture barrier 40 is in the form of an aluminum foil ranging in thickness from about 20 to 60 microns. Further, each of the polymer-impregnated decorative papers 9 is configured as a melamine-impregnated decorative kraft paper. As such, each of the papers 9 can include a solid color and/or decorative patterns. When patterns are employed in the decorative papers 9, an additional melamine-impregnated surface layer 8 can be added to the HPL to ensure that wear to the HPL does not result in a loss or degradation to the pattern(s) contained in the papers 9. Conversely, the surface layers 8 are unnecessary to include in the HPL for decorative papers 9 containing a solid color decorative aspect.

According to a further aspect of the laminated glass structures 100a depicted in FIGS. 2 and 2A, portions of the non-glass substrate 16 on the non-glass side (i.e., lower primary surface 28) of the laminated glass structure, or all of the non-glass substrate 16, can be subjected to compositional modifications to reduce moisture diffusivity. In particular, the lower portion of the non-glass substrate 16 or the all of the non-glass substrate 16 can be modified to decrease the rate of moisture ingress and egress on the side of the laminated glass structure 100a away from the flexible glass sheet 12. The net result is that the laminated glass structure 100a can obtain the same or similar benefits as the inclusion of the lower moisture barrier 40 in terms of bow resistance, moisture insensitivity and/or temperature insensitivity. Further, in some embodiments, these modifications can be made to a laminated glass structure 100a containing the lower moisture barrier 40 to further enhance its bow resistance, moisture insensitivity and/or temperature insensitivity.

By way of example only, the density of the stack 10 of the laminated glass structure 100a depicted in FIG. 2A can be modified to make it less susceptible to changes in moisture and/or temperature associated with subsequent processing of the laminated glass structure and/or environmental conditions associated with the structure. In particular, a stack 10 that includes a plurality of phenolic resin-impregnated kraft papers can be modified by increasing the formaldehyde to phenolic resin ratio and/or curing the stack 10 at a higher temperature (e.g., at 145 to 150° C. compared to 135 to 140° C. for a non-modified stack 10). The resulting stack 10 is expected to have a higher degree of cross-linking and, accordingly, a higher density and lower moisture diffusivity. As such, the lower moisture diffusivity associated with the stack 10 beneath the flexible glass sheet 12 can serve to balance or otherwise equilibrate the moisture ingress and egress within the laminated glass structure 100a, as containing a lower moisture barrier 40, an upper moisture barrier 44 (see FIGS. 3 and 3A) or no embedded moisture barriers.

Referring now to FIG. 3, an exemplary, laminated glass structure 100b is provided according to an embodiment of the disclosure. Unless otherwise noted, the laminated glass structure 100b depicted in FIG. 3 has the same or similar features and capabilities (i.e., bow resistance, moisture insensitivity and temperature insensitivity) as the laminated glass structure 100a depicted in FIG. 2. Further, like-numbered elements in the laminated glass structures 100a and 100b have the same or similar structures and functions. As shown in FIG. 3, the laminated glass structure 100b includes a non-glass substrate 16, a flexible glass sheet 12, a lower moisture barrier 40 and an upper moisture barrier 44. The non-glass substrate 16 includes one or more layers of polymer-impregnated paper, an upper primary surface 26 and a lower primary surface 28. The flexible glass sheet 12 has a thickness 13 and is laminated to the upper primary surface 26 of the non-glass substrate 16 with an adhesive 22. The lower moisture barrier 40 is disposed within the non-glass substrate 16 at a selected depth 42 from the lower primary surface 28. Further, the upper moisture barrier 44 is disposed within the non-glass substrate 16 at a selected depth 46 from the upper primary surface 26.

The laminated glass structure 100b depicted in FIG. 3 includes a lower moisture barrier 40 and an upper moisture barrier 44. The lower moisture barrier 40 is disposed within the non-glass substrate 16 at a selected depth 42 from the lower primary surface 28. The upper moisture barrier 44 is disposed within the non-glass substrate 16 at a selected depth 46 from the upper primary surface 26. In certain implementations, the selected depths 42 and 46 for the moisture barriers 40, 44 are, independently, about 1 micron to about half of the thickness 17 of the non-glass substrate 16. In some embodiments, the moisture barriers 40, 44 are equidistant from each other and the upper and lower primary surfaces 26, 28 of the non-glass substrate 16. According to one implementation, the moisture barriers 40, 44 are set at substantially equivalent selected depths 42, 46, respectively, from the respective primary surfaces 28, 26 of the non-glass substrate 16. More particularly, the lower and upper moisture barriers 40, 44 are added to the non-glass substrate 16 within the laminated glass structure 100b to decrease the rate of moisture ingress or egress on the side of the structure away from the flexible glass sheet 12 (i.e., the lower primary surface 28) and through the upper surface 26 (e.g., into the adhesive 22).

By selecting and/or positioning moisture barriers, e.g., a lower moisture barrier 40 and an upper moisture barrier 44, within the non-glass substrate 16 such that they exhibit a moisture diffusivity that is comparable to or less than the moisture diffusivity through the flexible glass sheet 12, bow 30 in the overall laminated glass structure 100b can be eliminated or otherwise reduced to an acceptable level in the laminated glass structure 100b, as-manufactured and through its lifetime. Dual moisture barriers, e.g., lower and upper moisture barriers 40, 44, selected and positioned according to the foregoing principles are more effective at eliminating bow, particularly through the lifetime of the laminated glass structure 100b as it experiences various environmental conditions, compared to conventional balancing papers often employed in the industry. Further, the moisture barriers 40, 44 are beneficially hidden or otherwise buried within the laminated glass structure 100b such that they do not detract from the aesthetics of the structure, affect its design flexibility in terms of possessing other decorative surfaces (e.g., on the upper and/or lower primary surfaces 26, 28), and/or impact the manufacturability and preparation of its final form (e.g., through cutting, sectioning, polishing and the like).

Compared to the laminated glass structure 100a (see FIG. 2) containing a lower moisture barrier 40 and free of an upper moisture barrier, the laminated glass structure 100b depicted in FIG. 3 containing a lower and an upper moisture barrier 40, 44 is particularly versatile from a manufacturing and shipment standpoint. Notably, the laminated glass structure 100b is resistant to bow, moisture and temperature changes as it may exist in an interim form during manufacturing before lamination of the flexible glass sheet 12. In particular, the laminated glass structure 100b contains dual moisture barriers in proximity to the upper and lower primary surfaces 26, 28 of the non-glass substrate 16, which serve to balance moisture ingress and egress in the laminated glass structure before it has been laminated with a flexible glass sheet 12. Accordingly, the use of dual moisture barriers 40, 44 can serve to reduce the overall bow 30 in the laminated glass structure 100b by ensuring that the structure experiences less bow prior to lamination of the flexible glass sheet 12 to the overall structure.

Referring again to moisture barriers 40, 44 of the laminated glass structure 100b depicted in FIG. 3, these barriers can have the same dimensions and composition as the lower moisture barrier 40 described earlier in connection with the laminated glass structure 100a depicted in FIG. 2. In certain aspects, the moisture barriers 40, 44 have the same or similar composition and/or thickness. In other implementations, the barriers 40, 44 have dissimilar compositions and/or thicknesses, for example, based on a desire for particular edge-on aesthetics for the laminated glass structure 100b.

Referring now to FIG. 3A, another exemplary embodiment of a laminated glass structure 100b is depicted in the form of a laminated glass structure having a high-pressure laminate (HPL). Unless otherwise noted, the laminated glass structure 100b depicted in FIG. 3A includes the same features as the laminated glass structure 100b depicted in FIG. 3. For example, the laminated glass structure 100b shown in FIG. 3A includes a non-glass substrate 16, a flexible glass sheet 12 and a lower moisture barrier 40. Further, the laminated glass structure 100b shown in FIG. 3A can exhibit the same functionality as the structure 100b depicted in FIG. 3, including bow resistance, moisture insensitivity and/or temperature insensitivity. In particular, the laminated glass structure 100b can exhibit a change in bow of no more than ±10 mm upon exposure to (a) a drying evolution at 70° C. for 24 hours; (b) a high humidity evolution at 23° C. with a 90% relative humidity for 7 days; and (c) a high humidity and temperature evolution at 40° C. with a 95% relative humidity for 96 hours. However, the non-glass substrate 16 of the laminated glass structure 100b depicted in FIG. 3A more particularly includes a stack 10 of polymer-impregnated papers, a lower moisture barrier 40, an upper moisture barrier 44, polymer-impregnated decorative papers 9, separate polymer-impregnated papers 11 and optional surface layers 8. In this configuration, the polymer-impregnated papers 11 are configured to assist or otherwise enable the joining of the polymer-impregnated decorative papers 9 to the lower and upper moisture barriers 40, 44, as shown in FIG. 3A.

In an exemplary embodiment, the laminated glass structure 100b has an overall thickness from about 4 mm to about 25 mm, and includes a non-glass substrate 16 in the form of an HPL with a stack 10 having about 1 to 100 phenolic resin-impregnated kraft papers, laminated under an above-ambient pressure. The lower and upper moisture barriers 40, 44 are in the form of an aluminum foil ranging in thickness from about 20 to 60 microns. Further, each of the polymer-impregnated decorative papers 9 is configured as a melamine-impregnated decorative kraft paper. As such, each of the papers 9 can include a solid color and/or decorative patterns. When patterns are employed in the decorative papers 9, an additional melamine-impregnated surface layer 8 can be added to either side of the HPL (i.e., at upper and/or lower primary surfaces 26, 28) to ensure that wear to the HPL does not result in a loss or degradation to the pattern(s) contained in the papers 9. Conversely, the surface layers 8 are unnecessary to include in the HPL for decorative papers 9 containing a solid color decorative aspect.

### Example 1

The following examples further demonstrate the embodiments of the disclosure. Conventional high pressure laminates (HPLs) were laminated to Corning® Willow® Glass (“Comp. Exs. 1, 2, and 3”) and conventional exterior grade HPLs (“Exs. 1A, 2A, and 3A) were laminated to Corning® Willow® Glass with 3M™ 8215 optically clear adhesive according to processes as understood by those with ordinary skill in the field of the disclosure. The non-glass substrates of the exterior grade HPLs were subjected to processing such that they exhibited a significantly higher degree of cross-linking to increase their density and reduce their moisture diffusivity, consistent with the principles outlined earlier in the disclosure. Further, examples of laminated glass structures with HPLs comprising 40 micron aluminum foil upper and lower moisture barriers and laminated to Corning® Willow® Glass (“Exs. 1B, 2B and 3B”) were prepared consistent with the laminated glass structures of the disclosure according to processes understood by those in the field of the disclosure. All Corning® Willow® Glass sheets and adhesive layers employed in the samples of Example 1 were 200 microns and 125 microns in thickness, respectively.

The samples of Example 1, each having a length of 36 inches, were measured for bow and then re-measured for bow after the listed environmental condition according to the modified test method based on European Standard EN438. The results of these measurements were then used to calculate an average bow value as shown below in Table 1. As is evidenced by the data, the laminated glass structures exhibit the least amount of average bow after each of the listed environmental conditions. In particular, these samples exhibited average bow amounts of (a) +7.0, (b) −4.3 and (c) −4.5 mm after being subjected to: (a) a drying evolution at 70° C. for 24 hours; (b) a high humidity evolution at 23° C. with a 90% relative humidity for 7 days; and (c) a high humidity and temperature evolution at 40° C. with a 95% relative humidity for 96 hours, respectively. These average bow amounts are markedly lower in magnitude than the average bow values associated with the conventional HPL and exterior grade HPL samples, indicative of the significant benefits afforded by the moisture barriers embedded within the non-glass substrate. It is believed that comparable results would be obtained with laminated glass structures processed identically to those of Exs. 1A, 2A and 3A with only a lower moisture barrier fabricated from a 40 micron aluminum foil. Further, it is evident from the data in Table 1 that the exterior grade HPL samples exhibited lower amounts of average bow in comparison to the average bow amounts exhibited by the conventional HPL samples, indicative of the beneficial effect of increasing the degree of cross-linking in the non-glass substrate.

TABLE 1

| | Non-Glass | Environmental | Average Bow |
|---|---|---|---|
| Example | Substrate Description | Condition | Change (mm) |
| Comp. Ex. 1 | Conventional HPL | 70° C. for 24 hours | +13.3 |
| Ex. 1A | Exterior grade HPL | 70° C. for 24 hours | +7.3 |
| Ex. 1B | HPL with Al upper and lower moisture | 70° C. for 24 hours | +7.0 |
| | barriers | | |
| Comp. Ex. 2 | Conventional HPL | 23° C./90% RH/7 | −9.7 |
| | | days | |
| Ex. 2A | Exterior grade HPL | 23° C./90% RH/7 | −7.7 |
| | | days | |
| Ex. 2B | HPL with Al upper and lower moisture | 23° C./90% RH/7 | −4.3 |
| | barriers | days | |
| Comp. Ex. 3 | Conventional HPL | 40° C./95% RH/96 hrs | −16.7 |
| Ex. 3A | Exterior grade HPL | 40° C./95% RH/96 hrs | −12.5 |
| Ex. 3B | HPL with Al upper and lower moisture | 40° C./95% RH/96 hrs | −4.5 |
| | barriers | | |

It should be emphasized that the above-described embodiments of the present disclosure, including any embodiments, are merely possible examples of implementations, merely set forth for a clear understanding of various principles of the disclosure. Many variations and modifications may be made to the above-described embodiments of the disclosure without departing substantially from the spirit and various principles of the disclosure. All such modifications and variations are intended to be included herein within the scope of this disclosure and the present disclosure and protected by the following claims.

What is claimed is:

1. A laminated glass structure, comprising:
a non-glass substrate comprising one or more layers of polymer-impregnated paper, an upper primary surface and a lower primary surface; and
a flexible glass sheet having a thickness of no greater than 0.3 mm laminated to the upper primary surface of the non-glass substrate with an adhesive,
wherein the non-glass substrate comprises a lower moisture barrier at a selected depth from the lower primary surface.

2. The structure according to claim 1, wherein the structure exhibits a change in bow of no more than ±10 mm upon exposure to a drying evolution at 70° C. for 24 hours.

3. The structure according to claim 1, wherein the structure exhibits a change in bow of no more than ±10 mm upon exposure to a high humidity evolution at 23° C. with a 90% relative humidity for 7 days.

4. The structure according to claim 1, wherein the structure exhibits a change in bow of no more than ±10 mm upon exposure to a high humidity and temperature evolution at 40° C. with a 95% relative humidity for 96 hours.

5. The structure according to claim 1, wherein the lower moisture barrier comprises an aluminum foil having a thickness from about 20 to about 60 microns.

6. The structure according to claim 1, wherein:
the lower moisture barrier has a thickness from about 20 to about 60 microns;
the lower moisture barrier comprises a material selected from the group consisting of a glass, a polymer, a metal, a ceramic, and a combination thereof; and
the lower moisture barrier exhibits a moisture diffusivity of no more than 10,000 times the moisture diffusivity of the flexible glass sheet at 45° C.

7. The structure according to claim 1, wherein the non-glass substrate further comprises a plurality of polymer-impregnated papers.

8. The structure according to claim 1, wherein a total thickness of the non-glass substrate, the flexible glass sheet and the adhesive is from about 4 mm to about 25 mm.

9. The structure according to claim 14, wherein the upper and lower primary surfaces each comprise a melamine-impregnated decorative layer.

10. The structure according to claim 1, wherein the non-glass substrate further comprises an upper portion in proximity to the upper primary surface and a lower portion in proximity to the lower primary surface, and the lower portion exhibits lower moisture diffusivity than the moisture diffusivity of the upper portion.

11. The structure according to claim 1, wherein the non-glass substrate comprises an upper moisture barrier at a selected depth from the upper primary surface.

12. The structure according to claim 11, wherein each of the upper moisture barrier and the lower moisture barrier comprises an aluminum foil having a thickness from about 20 to about 60 microns.

13. The structure according to claim 11, wherein:
each of the upper moisture barrier and the lower moisture barrier has a thickness from about 20 to about 60 microns;
each of the upper moisture barrier and the lower moisture barrier comprises a material selected from the group consisting of a glass, a polymer, a metal, a ceramic, and a combination thereof; and
each of the upper moisture barrier and lower moisture barrier exhibits a moisture diffusivity of no more than 10,000 times the moisture diffusivity of the flexible glass sheet at 45° C.

14. A laminated glass structure, comprising:
a non-glass substrate comprising a high pressure laminate (HPL), an upper primary surface and a lower primary surface; and
a flexible glass sheet having a thickness of no greater than 0.3 mm laminated to the upper primary surface of the non-glass substrate with an adhesive,
wherein the non-glass substrate comprises a lower moisture barrier at a selected depth from the lower primary surface, the moisture barrier having a thickness from about 20 microns to about 60 microns,
wherein a total thickness of the non-glass substrate, the flexible glass sheet and the adhesive is from about 4 mm to about 25 mm, and
further wherein the structure exhibits a change in bow of no more than ±10 mm upon exposure to (a) a drying evolution at 70° C. for 24 hours; (b) a high humidity evolution at 23° C. with a 90% relative humidity for 7 days; and (c) a high humidity and temperature evolution at 40° C. with a 95% relative humidity for 96 hours.

15. The structure according to claim 14, wherein the lower moisture barrier comprises an aluminum foil.

16. The structure according to claim 14, wherein:
the lower moisture barrier comprises a material selected from the group consisting of a glass, a polymer, a metal, a ceramic, and a combination thereof; and
the lower moisture barrier exhibits a moisture diffusivity of no more than 110% of the moisture diffusivity of the flexible glass sheet between 23° C. and 70° C.

17. The structure according to claim 14, wherein each of the upper primary surface and the lower primary surface comprises a melamine-impregnated decorative layer.

18. The structure according to claim 14, wherein the non-glass substrate further comprises an upper portion in proximity to the upper primary surface and a lower portion in proximity to the lower primary surface, and the lower portion exhibits lower moisture diffusivity than the moisture diffusivity of the upper portion.
